(19) United States
(12) Patent Application Publication
(10) Pub. No.: US 2023/0169395 A1
(43) Pub. Date: Jun. 1, 2023

(54) ARTIFICIAL INTELLIGENCE BASED METHODS AND SYSTEMS FOR QUANTIFYING CONFIDENCE IN INSIGHTS OF AN INPUT DATASET

(71) Applicant: DATANOMERS LLC, Freehold, NJ (US)

(72) Inventors: Pranay K. POGDE, San Jose, CA (US); Deepak DUBE, Colts Neck, NJ (US)

(21) Appl. No.: 17/539,931

(22) Filed: Dec. 1, 2021

(51) Int. Cl. G06N 20/00

(52) U.S. Cl. CPC G06N 20/00

(57) ABSTRACT

Embodiments of the present disclosure provide systems and methods for mining outcomes from a given dataset and quantifying the confidence in the outcomes. The method includes receiving an input data file for extracting a set of data attributes and a plurality of data points from the input data file based on a first machine learning model. Further, the method includes generating a plurality of outcomes based at least on the set of data attributes and the plurality of data points. The method includes computing a confidence score for each of the plurality of outcomes based on a second machine learning model. Further, the method includes determining a threshold factor for the confidence score. The method includes displaying the outcome, the confidence score, and the threshold factor associated with the outcome at a user interface (UI) rendered by an application based on selection of the outcome from the plurality of outcomes.

### TECHNICAL FIELD

The present disclosure relates to artificial intelligence processing systems and, more particularly to, applying machine learning (ML) on an input dataset (related to business, education, healthcare, etc.) for mining insights and/or outcomes from the input dataset, quantifying the confidence in the insights and explaining the insights for enabling end-users to augment their intelligence.

### BACKGROUND

In recent times, there have been various kinds of implementations of artificial intelligence (AI) techniques into computer-related machines, where AI algorithms outperform humans' (or users') capabilities in some areas of applications, thus offering a multitude of benefits and advantages. Typically, the machine learning (ML) models are used to perform one or more functions such as, capturing, processing, and analyzing input data to produce an output that includes numerical or symbolic information.

However, in some cases, the AI and ML algorithms may be prone to produce false output due to misinterpretation of the input data. Often, steps or actions leading to false output may be undetectable, unpredictable, and may have no direct intervention resolution. This leads to significant consequences due to incorrect decisions taken by the users based on false output. Further, the users may not be able to interpret or understand the output by the AI and ML algorithms, as the output is in form of machine code. Additionally, the users often tend to seek an explanation or reasons for the output for augmenting their intelligence. However, the AI and machine learning algorithms are often incapable of explaining the output or decisions or actions to the human users, which further leads to poor decision making.

Thus, there exists a technological need for technical solutions for providing an explanation of the output produced by AI and ML algorithms.

### SUMMARY

Various embodiments of the present disclosure provide a computer-implemented method. The computer-implemented method performed by a server system includes receiving an input data file from a user through an application installed in a user device associated with the user. The method includes extracting a set of data attributes and a plurality of data points from the input data file based, at least in part, on a first machine learning model. Further, the method includes generating a plurality of outcomes based at least on the set of data attributes and the plurality of data points. The plurality of outcomes is generated based, at least in part, on the first machine learning model. The first machine learning model corresponds to an optimal machine learning model trained with training data to identify the set of data attributes and generate the plurality of outcomes by analyzing the input data file. The method includes computing a confidence score for each of the plurality of outcomes based, at least in part, on a second machine learning model. Further, the method includes determining a threshold factor for the confidence score associated with each of the plurality of outcomes. The threshold factor is indicative of an acceptable threshold associated with the confidence score of each of the plurality of outcomes. The method includes displaying an outcome, the confidence score, the threshold factor associated with the outcome at a user interface (UI) rendered by the application in the user device based on user selection of the outcome from the plurality of outcomes.

In an embodiment, a server system is disclosed. The server system includes a communication interface, a memory comprising executable instructions and a processor communicably coupled to the communication interface and the memory. The processor is configured to cause the server system to perform at least receive an input data file from a user through an application installed in a user device associated with the user. The server system is caused to extract a set of data attributes and a plurality of data points from the input data file based, at least in part, on a first machine learning model. Further, the server system is caused to generate a plurality of outcomes based at least on the set of data attributes and the plurality of data points. The plurality of outcomes are generated based, at least in part, on the first machine learning model. The first machine learning model corresponds to an optimal machine learning model trained with training data to identify the set of data attributes and generate the plurality of outcomes by analyzing the input data file. The server system is caused to compute a confidence score for each of the plurality of outcomes based, at least in part, on a second machine learning model. The server system is further caused to determine a threshold factor for the confidence score associated with each of the plurality of outcomes. The threshold factor is indicative of an acceptable threshold associated with the confidence score of each of the plurality of outcomes. The server system is caused to display an outcome, the confidence score, the threshold factor associated with the outcome at a user interface (UI) rendered by the application in the user device based on user selection of the outcome from the plurality of outcomes.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 illustrates an exemplary representation of an environment related to at least some embodiments of the present disclosure;

FIG. 2 is a simplified block diagram of a server system, in accordance with an embodiment of the present disclosure;

FIG. 3 illustrates an architecture depicting various machine learning models, in accordance with an embodiment of the present disclosure;

FIG. 4 represents a flow chart for training machine learning (ML) models associated with the server system, in accordance with an embodiment of the present disclosure;

FIG. 5 represents an example representation of a user interface (UI) depicting a home page of an application managed by the server system, in accordance with an embodiment of the present disclosure;

FIGS. 6A-6D, collectively, represent example representation of user interfaces (UI) for pre-processing of training data, in accordance with an embodiment of the present disclosure;

FIGS. 7A and 7B, collectively, represent example representation of user interfaces (UI) for training the ML models with the processed training data, in accordance with an embodiment of the present disclosure;

FIGS. 8A-8D, collectively, represent example representation of user interfaces (UI) for determining a plurality of outcomes associated with the input data file, in accordance with an embodiment of the present disclosure;

FIG. 9 illustrates a flow diagram of a computer-implemented method for generating the plurality of outcomes from a given input data file and quantifying the confidence in each of the plurality of outcomes with the confidence score, in accordance with an embodiment of the present disclosure; and

FIG. 10 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide systems and methods for determining a plurality of outcomes from the input dataset, quantifying the confidence in each of the plurality of outcomes, and explaining the plurality of outcomes for enabling end-users to augment their intelligence. In at least one embodiment, the present disclosure provides a server system. The server system includes a communication interface, a processor, and a memory. In addition, the processor is operatively coupled with the memory to execute instructions stored in the memory to predict the outcomes, quantify the confidence in the outcomes and explain the outcomes to the end-users (e.g., customers).

The server system is configured to receive an input data file from a user through an application installed in a user device associated with the user. The server system extracts a set of data attributes and a plurality of data points from the input data file based, at least in part, on a first machine learning model. Further, the server system is configured to generate a plurality of outcomes based at least on the set of data attributes and the plurality of data points. The plurality of outcomes are generated based, at least in part, on the first machine learning model. The first machine learning model corresponds to an optimal machine learning model trained with training data to identify the set of data attributes and generate the plurality of outcomes by analyzing the input data file. Thereafter, the server system computes a confidence score for each of the plurality of outcomes based, at least in part, on a second machine learning model. More specifically, the server system is configured to filter the input data file by applying each outcome generated by the first machine learning model and generating the confidence score for each of the plurality of outcomes based at least on analyzing the efficacy of each of the plurality of outcomes with the filtered input data file. It should be noted that the first and second machine learning models are trained with similar training data. The training data comprises a plurality of datasets, features associated with each dataset of the plurality of datasets, and the plurality of outcomes derived from the features.

During the training phase, the server system is configured to receive the training data as input for training one or more machine learning models. Thereafter, the server system pre-processes the training data, prior to training one or more machine learning models. Pre-processing of the training data includes receiving inputs related to a set of features associated with the training data, the set of features correspond to the set of data attributes. Further, the server system automatically determines a data type associated with each feature of the set of features and generates a statistic table based at least on the set of features and the data type associated with each feature. Furthermore, the server system receives inputs related to the selection of at least one feature from the set of features for extracting the set of data attributes from the input data file and determining the outcome based on the set of data attributes, and coordinates associated with the set of features. Thereupon, the server system inputs the training data to the one or more machine learning models based at least on the selection of a type of machine learning model to be trained. In one embodiment, the machine learning models are implemented as at least one of predictive models, time-series models, and forecasting models.

In an embodiment, the server system is configured to evaluate a K-value and an accuracy value for each of the one or more machine learning models (i.e. classification models) based on analyzing an outcome prediction rate associated with each of the one or more machine learning models. The server system further determines the optimal machine learning model from the one or more machine learning models based at least on the K-value and the accuracy value. As explained above, the optimal machine learning model corresponds to the first machine learning model. In another embodiment, the server system is configured to evaluate an R-squared and an RMSE value for each of the machine learning models based on analyzing the outcome prediction rate associated with each of the machine learning models (i.e. regression models). Thereafter, the server system determines the optimal machine learning model based at least on the R-value and the RMSE value.

Additionally, the server system is configured to determine a threshold factor for the confidence score associated with each of the plurality of outcomes. The threshold factor is indicative of an acceptable threshold associated with the confidence score of each of the plurality of outcomes.

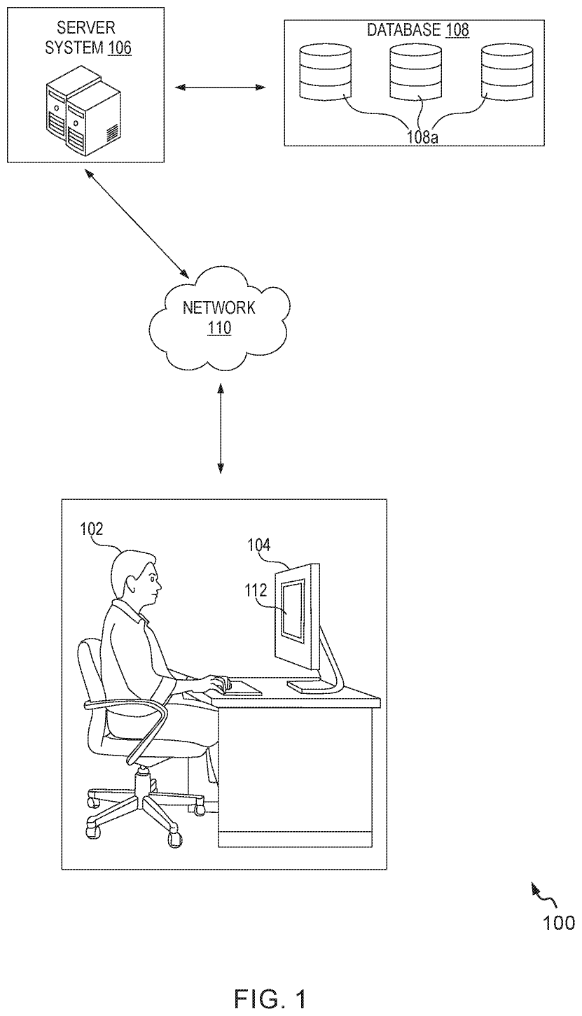

Various embodiments of the present invention are described hereinafter with reference to FIG. 1 to FIG. 10.

FIG. 1 illustrates an exemplary representation of an environment 100 related to at least some example embodiments of the present disclosure. Although the environment 100 is presented in one arrangement, other embodiments may include the parts of the environment 100 (or other parts) arranged otherwise depending on, for example, automatically determining insights (or rules and limits) from an input dataset, quantifying the confidence in insights, and providing explanation or reasons to each of the insights for augmenting intelligence of users, and so forth. The environment 100 generally includes a plurality of entities, for example, a user device 104 associated with a user 102 and a server system 106, each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. For example, the network 110 may include multiple different networks, such as a private network made accessible by the server system 106, separately, and a public network (e.g., the Internet etc.).

The user 102 may be a customer availing services offered by the server system 106. In one example, the user 102 may seek an explanation of the outcome produced by the server system 106 in any field such as, business, healthcare, education and the like. The user device 104 is associated with the user 102. In one example, the user 102 is an owner of the user device 104. In an embodiment, the user device 104 is equipped with an instance of an application 112 for facilitating an interaction between the user 102 and the server system 106 via the network 110. The application 112 is a set of computer-executable codes configured to provide user interfaces (UIs) for displaying a plurality of outcomes, explanations or reasons to each of the plurality of outcomes to the user 102, which will be explained further in detail.

In one embodiment, the application 112 may be hosted and managed by the server system 106. In an embodiment, the server system 106 may install the application 112 in the user device 104 in response to a request received from the user device 104 via the network 110. In another embodiment, the application 112 may be pre-installed in the user device 104. In some embodiments, the server system 106 may provide the application 112 as a web service accessible through a website. In such a scenario, the application 112 may be accessed through the website over the network 110 using a web browser application (e.g., Google Chrome, Safari, Mozilla Firefox, Opera, Microsoft Edge, etc.) installed in the user device (e.g., the user device 104).

The server system 106 is configured to perform one or more of the operations described herein. The server system 102 is configured to receive an input data file from the user 102 through the application 112. The server system 106 is further configured to predict the plurality of outcomes that are easily interpreted or understandable by the user 102. The server system 106 is a separate part of the environment 100 and may operate apart from (but still in communication with, for example, via the network 110) any third party external servers (to access data to perform the various operations described herein). In addition, the server system 106 should be understood to be embodied in at least one computing device in communication with the network 110, which may be specifically configured, via executable instructions, to perform as described herein, and/or embodied in at least one non-transitory computer-readable media.

In an example, the user 102 (for example, working in the healthcare industry) may want to keep track of his/her blood pressure. In this scenario, the application 112 managed by the server system 106 is configured to provide UIs (such as, question and answer (Q&A) based user interfaces) to the user 102 to perform operations such as, uploading the input data file related to blood pressure readings, processing the input data file, and building artificial intelligence (AI) and/or machine learning (ML) models for augmented intelligence functions.

More specifically, the server system 106 is configured to receive the input data file containing the blood pressure readings of the user 102 for over a time-period (e.g., 1 month, 2 months, 6 months etc.). The server system 106 with access to a database 108 may be configured to determine the outcome (e.g., whether blood pressure of the user 102 is high, low, or normal) based on analyzing the input data file. The database 108 may store trained ML models and algorithms (see, 108a) required for the server system 106 to perform one or more operations described herein. In one embodiment, the database 108 may be incorporated in the server system 106 or maybe an individual entity connected to the server system 106, or maybe a database stored in a cloud storage.

The server system 106 may use feature engineering to identify and extract a set of data attributes and a plurality of data points (for example, the blood pressure readings of the user 102 over the time-period) from the input data file. In general, feature engineering is a process of extracting some features (e.g., properties, attributes, characteristics, etc.) from raw data. The server system 106 is further configured to generate the outcome that is in form of human (i.e., the user 102) understandable rules and thresholds based at least on the set of data attributes and the data points. Thereafter, the server system 106 is configured to quantify the accuracy of each of the plurality of outcomes with weights. The weights associated with each outcome enable the user 102 to decide which of the plurality of outcomes are acceptable (or trusted) (based on the weights), and hence need to be considered and which of the plurality of outcomes are to be neglected. Additionally, the server system 106 is configured to provide an explanation for each outcome to augment the intelligence of the user 102.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

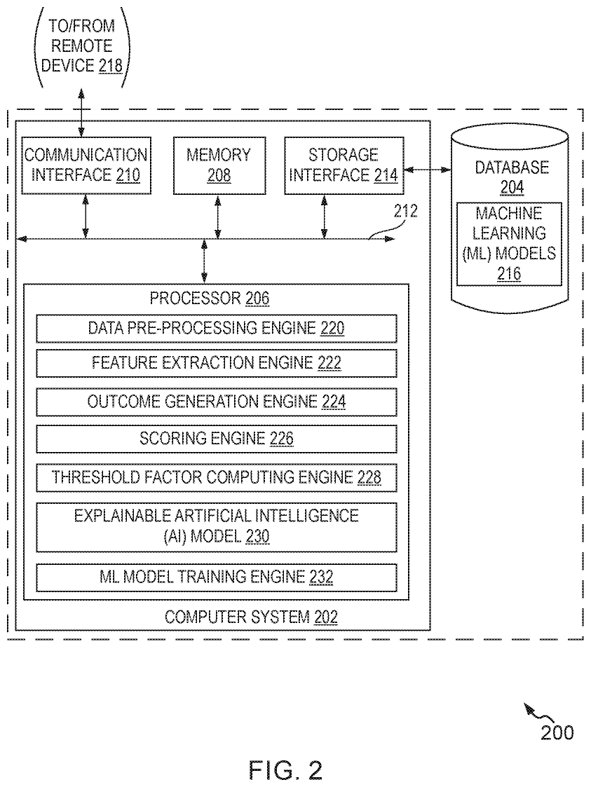

FIG. 2 is a simplified block diagram of a server system 200, in accordance with an embodiment of the present disclosure. The server system 200 is an example of the server system 106 of FIG. 1. In some embodiments, the server system 200 is embodied as a cloud-based and/or SaaS-based (software as a service) architecture.

The server system 200 includes a computer system 202 and a database 204. The computer system 202 includes at least one processor 206 for executing instructions, a memory 208, a communication interface 210, and a storage interface 214 that communicate with each other via a bus 212.

In some embodiments, the database 204 is integrated within computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 is configured to store one or more machine learning (ML) models 216.

Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the processor 206 is capable of communicating with a remote device 218 such as, the user device 104, or communicated with any entity connected to the network 110 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a data pre-processing engine 220, a feature extraction engine 222, an outcome generation engine 224, a scoring engine 226, a threshold factor computing engine 228, an explainable artificial intelligence (AI) model 230, and an ML model training engine 232. It should be noted that components, described herein, can be configured in a variety of ways, including electronic circuitries, digital arithmetic and logic blocks, and memory systems in combination with software, firmware, and embedded technologies.

The data pre-processing engine 220 includes suitable logic and/or interfaces for receiving the input data file through the application 112 installed in the user device 104 associated with a user (such as the user 102). Examples of the input data file may include, but are not limited to, medical reports, audit reports, weather data, and the like. In some implementations, the data pre-processing engine 220 executes one or more preprocessing operations on the received input data file. Examples of pre-processing operations performed by the data pre-processing engine 220 include normalization operations, splitting of datasets, merging of datasets, and other suitable preprocessing operations.

More specifically, the data pre-processing engine 220 is configured to extract information such as a number of entries or records in the input data file with the execution of the trained ML models 216. In one example, the input data file may include medical records consisting of blood pressure readings of a patient (e.g., the user 102) over a period of time. In one example, the period of time may be of 1 month, 2 months, 6 months, and the like.

During the training phase, the data pre-processing engine 220 receives the training data as an input, prior to training the ML models 216. Further, the data pre-processing engine 220 may receive inputs related to a set of features associated with the training data. It should be noted that the set of features correspond to the set of data attributes that will be extracted from the input data file in the future instance. Thereafter, the data pre-processing engine 220 generates a statistic table based at least on the set of features and the data type associated with the set of features and the like. Further, the statistic table is provided as input for training an ML model of the ML models 216. It will be apparent that the data pre-processing engine 220 is configured to pre-process the input data file, for example, determining data types, removal of outliers, and the like, based on the training data.

The feature extraction engine 222 includes suitable logic and/or interfaces for analyzing the input data file to determine the set of data attributes. It should be understood that the set of data attributes may vary based on the type of the input data file. The feature extraction engine 222 extracts the features or the set of data attributes from the input data file based at least on parameters such as, the importance of the data attributes in deriving the outcome, correlation of the data attributes with each other, and threshold associated with the data attributes. The feature extraction engine 222 with access to the training data of the ML models 216 extracts the data attributes from the input data file by analyzing the input data file based on the parameters discussed above.

The outcome generation engine 224 includes suitable logic and/or interfaces for analyzing the set of data attributes and the data points extracted from the input data file to generate an outcome. More specifically, the outcome generation engine 224 with access to trained data of the ML models 216 employs reverse engineering technique to concatenate the set of data attributes extracted from the input data file and the data points to generate the outcome that is in a human-understandable format. In general, reverse engineering (also known as backward engineering) is a method through which a system, software, machine, device, etc. utilizes deductive reasoning to accomplish a task without very little insight about exactly how it does so.

As explained above, the training data is pre-processed, prior to training the ML models 216. More specifically, the ML model training engine 232 includes suitable logic and/or interfaces for training the ML models 216 based on the input dataset. In one embodiment, the ML models 216 may be implemented as one of: a) predictive models, b) time-series models, and c) augmented intelligence models. In one scenario, the pre-processed training data may be fed as an input to the predictive models associated with the ML models 216. The predictive models may include, but are not limited to, Bagged decision trees with information gain model, K-nearest neighbors, AdaBoost Decision Trees, boosted decision trees with information gain, neural network classification, and the like. Thereafter, the predictive models may be built or trained with the pre-processed training data. Further, the processor 206 is configured to compute an outcome prediction rate for each of the ML models 216 (i.e., the predictive models). Specifically, the processor 206 computes a K-value (or Kappa value) and an accuracy value for each of the predictive models (or classification ML models) associated with the ML models 216 based on analyzing the outcome prediction rate of each of the predictive models. In general, the kappa statistic (or K-value) is a measure of inter-reliability of the instances classified by the machine learning models matched the data labeled as ground truth, controlling for the accuracy of a random classifier as measured by the expected accuracy.

Based on the evaluation of the K-value and the accuracy value for each of the predictive models associated with the ML models 216, an optimal machine learning model from the one or more machine learning models is selected. More specifically, each of the predictive models is ranked based on the K-value and the accuracy value. As such, the ML model of the ML models 216 that possess the highest K-value and accuracy value is selected as the optimal ML model for prediction. Further, the optimal machine learning model corresponds to a first machine learning model used for mining the plurality of outcomes based on receipt of the input data file in a future instance. Similarly, the processor 206 may be configured to evaluate an R-squared and an RMSE value for the regression ML models associated with the ML models 216 based on analyzing the outcome prediction rate associated with each of the ML models 216. Thereafter, the processor 206 may determine the optimal Ml model (or the optimal regression model) from the ML models 216 based at least on the R-value and the RMSE value. Thus, it is understood that the first machine learning model trained with the training data is configured to identify the set of data attributes and generate the outcome by analyzing the input data file. Without loss of generality, each of the outcomes generated by the outcome generation engine 224 is a collection of rules, where each rule is a condition on an attribute comparing it with a threshold.

In an embodiment, an ensemble model may be built by combining multiple ML models of the predictive models in the prediction process. In another embodiment, the first machine learning model may be implemented as the augmented intelligence model. In this scenario, the first machine learning model corresponds to an augmented analytical model. The first machine learning model may be modeled or built as a combination of white-box models based at least on decision tree algorithm and linear regression algorithm. In general, white-box ML models are the type of models that clearly explain the steps involved in performing predictions (or the outcomes) and the influencing variables or the set of data attributes for deriving the outcomes. In other words, the white-box models provide the features that are understandable and facilitate the ML process to be transparent. Thus, it is evident that the feature extraction engine 222 and the outcome generation engine 224 with access to the first machine learning model associated with the ML models 216 provide the set of data attributes and the plurality of outcomes respectively, which are in a human-understandable format.

The scoring engine 226 includes suitable logic and/or interfaces for quantifying the confidence in the outcome generated by the outcome generation engine 224. More specifically, the scoring engine 226 computes a confidence score for each of the plurality of outcomes based, at least in part, on a second machine learning model. The second machine learning model is associated with the ML models 216 that are trained with the training data similar to the training data of the first machine learning model. In one embodiment, the second machine learning model may include historical outcomes generated based at least on the data attributes or features and corresponding confidence scores.

More specifically, the second machine learning model is modeled using parameters such as root mean square error function (RMSE), accuracy, the proportion of the input data file upon filtering outliers from the input data file, perception for computing the confidence score for each data attribute relative to the population of the training data. The root mean square error (RMSE) function (or purity of the filtered data) is an accuracy measure that enables the scoring engine 226 to determine the vicinity of the outcome of interest based on applying the generated outcome to the training data. Further, the proportion of the input data file upon filtering outliers from the input data file is a coverage measure. In other words, the coverage measure implies the proportion of the filtered input data file from the training data.

Based on the aforementioned parameters, the scoring engine 226 is configured to calculate the confidence score for the plurality of outcomes. In other words, the confidence score is modeled as a function of the aforementioned parameters and can be computed using the following equation (Eq. 1):

Confidence score,f(P1,g(P2),P3,P4)=f1(P1)×f2(g(P2))×f3(P3)×f4(P4) (Eq. 1)
Where P1, P2, P3, and P4 are parameters independent of each other. More specifically, the parameters P1, P2, P3, and P4 correspond to purity, proportion, population, and perception, respectively.

It should be noted that the parameter P2 is modulated by another function “g”. Further, the parameter P4 is computed as:

f4(P4)=f41(P41)*f42(P42) (Eq. 2)

Where P41 and P42 represent the number of perceptions.

As such, the scoring engine 226 with access to the second machine learning model computes the confidence score as a numerical representation for each outcome as explained above. The confidence score corresponds to weightage (or weights) assigned to the outcome generated by the outcome generation engine 224. For example, the confidence score may be bounded between 0 and 1. The confidence score allows the users (e.g., the user 102) to trust the outcome generated by the server system 200 which is explained further in detail.

In an embodiment, the second machine learning model corresponds to the augmented analytical model similar to the first machine learning model. In some embodiments, the second machine learning model may be implemented as one of the predictive models.

The threshold factor computing engine 228 includes suitable logic and/or interfaces for computing a threshold factor for the confidence score associated with each outcome. The threshold factor is indicative of an acceptable threshold associated with the confidence score for each of the plurality of outcomes. More specifically, the threshold factor specifies a value above which confidence scores are acceptable. The threshold factor for each of the confidence scores assigned to the plurality of outcomes may be stored in the database 204. Thus, the threshold factor computing engine 228 with access to the database 204 computes the threshold factor for the confidence score assigned to each outcome. The plurality of outcomes assigned with confidence score greater than the threshold factor are more trusted outcomes than the plurality of outcomes assigned with confidence score lower than the threshold factor, thus enabling the user 102 to take decisions feasibly and automate operations in their environment. Additionally, the threshold factor computing engine 228 provides an indication for the confidence score based on determining whether the confidence score is above or below the threshold factor (or the acceptable threshold).

The explainable artificial intelligence (AI) model 230 includes suitable logic and/or interfaces for providing explanations and/or reasons for each of the outcomes (or the set of data attributes influencing the outcome). The explainable AI model 230 may be trained with the training data similar to the training data of the first and second machine learning models. Thus, the explainable AI model 230 explains the reasons for ML models predictions (or the outcome). The reasons are expressed as a rule of various predictors (or the outcomes), thus creating the outcomes that are actionable. More specifically, the explainable AI model 230 explains the rules associated with the outcome by encoding the set of data attributes associated with each outcome as a condition. The condition indicates a threshold associated with each data attribute of the set of data attributes along with a comparative operator for enabling comparison of the set of data attributes associated with each outcome and the threshold of each data attribute. The comparative operator provides information to the user 102 for attaining the desired level or threshold associated with the data attribute to achieve the desired outcome.

Further, the processor 206 may display the confidence score, rules (and/or reasons) and the threshold factor associated with the confidence score of the outcome at a graphical user interface (GUI) rendered by the application 112 in the user device 102 based on user selection of the outcome in the application 112.

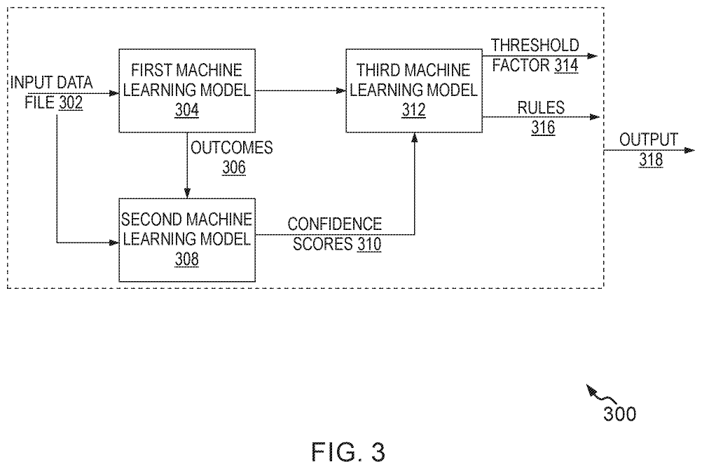

Referring to FIG. 3, a simplified block diagram representation 300 of an architecture depicting the various machine learning models 216 is illustrated, in accordance with an embodiment of the present disclosure. As shown, an input data file 302 is provided as an input to a first machine learning (ML) model 304. In one example, the input data file 302 is identical to the input data file explained above in FIG. 2. The first ML model 302 is configured to extract the set of attributes and the data points from the input data file 302. The first ML model 302 is further configured to derive outcomes 306 that are in a human-understandable format. Specifically, the first ML model 302 is trained with the training data for extracting the data attributes and the data points from the input data file to derive the outcomes 306 based on analyzing the set of data attributes and the data points.

Further, the outcomes 306 and the input data file 302 are provided as input to a second machine learning (ML) model 308. The second ML model 308 is configured to compute a confidence score 310 for each of the outcomes 306. More specifically, the second ML model 308 is configured to filter the input data file 302 by applying outcomes 306 generated by the first ML model 302. The second ML model 308 generates the confidence scores 310 for the outcomes 306 based on at least analyzing the efficacy of each of the outcomes 306 with the filtered input data file. Thereafter, a threshold factor 314 for the confidence scores 310 is auto computed by a third machine learning (ML) model 312 based on receipt of the confidence scores 310 (i.e., output from the second ML model 308) as an input. Additionally, the third ML model 310 is configured to determine rules (and/or reasons) 316 pertaining to each outcome 306. Thus, it is evident that the block diagram representation 300 provides an output 318. The output 318 includes the outcomes 306, the confidence scores 310 associated with each of the outcome 306, the threshold factor 314, and the rules 316. For example, the output 318 on an input data about a patients' blood pressure readings, maybe like “Blood pressure is high because (work stress level is high), (minutes of exercise is 5 minutes which is less than 20 minutes) and (hours of sleep is 5 which is less than 7.5). Further, the aforementioned operations for providing the output 318 are herein explained in detail with reference to FIG. 2, and therefore, they are not reiterated for the sake of brevity.

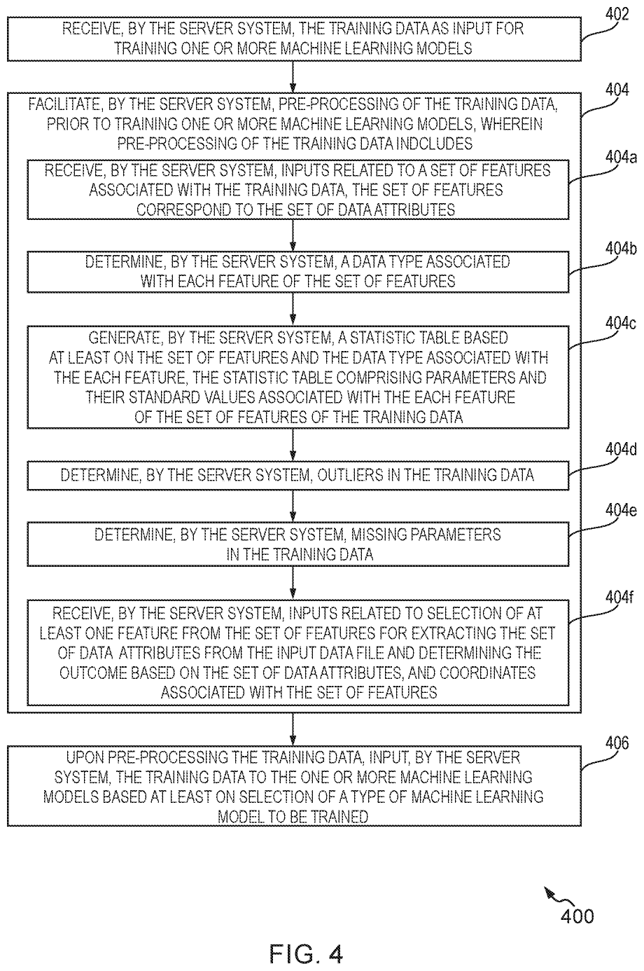

FIG. 4 represents a flow chart 400 for training ML models (such as the ML models 216) associated with the server system 200, in accordance with an embodiment of the present disclosure. The ML models are trained based at least on the selection of a type of ML model (e.g., predictive model, time series model, and augmented intelligence) to be trained. The sequence of operations of the flow chart 400 may not be necessarily executed in the same order as they are presented. Further, one or more operations may be grouped and performed in the form of a single step, or one operation may have several sub-steps that may be performed in parallel or in a sequential manner.

At 402, the server system 200 receives the training data as input for training one or more machine learning models (such as the ML models 216). Typically, the ML models 216 may be trained with training data including one of a plurality of datasets, features associated with each dataset of the plurality of datasets, and a plurality of outcomes derived from the features, and the like. The training data may be pre-processed, prior to training the ML models 216.

At 404, the server system 200 pre-processes the training data, prior to training the one or more machine learning models. The pre-processing of the training data for training the ML models 216 is performed at steps 404a-404f.

At 404a, the server system 200 receives inputs related to a set of features associated with the training data. The set of features correspond to the set of data attributes being extracted from the input data file at future instances. The user (such as the user 102) may provide inputs in the application 112 related to the set of features associated with the particular dataset (or the input training data) for deriving the plurality of outcomes.

At 404b, the server system 200 determines a data type associated with each feature of the set of features. In an embodiment, the user 102 may provide inputs related to the data type associated with each feature in the application 112. At 404c, the server system 200 generates a statistic table based at least on the set of features and the data type associated with each feature. The statistic table includes parameters and their standard values associated with each feature of the set of features of the training data.

At 404d, the server system 200 determines outliers in the training data. The server system 200 is configured to eliminate the outliers in the training data based at least on the inputs from the user 102. For instance, the server system 200 may delete the outliers in the training data, if the user provides input related to the removal of the outliers. Further, at 404e, the server system 200 determines missing parameters in the training data. As such, the server system 200 may auto-fill the missing parameters in the training data based at least on receipt of the user inputs. The auto-filling of the missing parameters in the training data is based at least on imputation algorithms.

At 404f, the server system 200 inputs related to the selection of at least one feature from the set of features for extracting the set of data attributes from the input data file and determining the outcome based on the set of data attributes, and coordinates associated with the set of features.

At 406, the server system 200 inputs the training data to the one or more ML models (such as the ML models 216) based at least on the selection of a type of machine learning model to be trained, upon pre-processing the training data.

In one example embodiment, the ML models 216 may be implemented as the predictive models. Thus, training the predictive models further includes evaluating the K-value (or Kappa value) and the accuracy value for each of the ML models 216 based on analyzing the outcome prediction rate associated with each of the ML models 216. Thereafter, the server system 200 determines the optimal machine learning model from the ML models 216 based at least on the K-value and the accuracy value. The optimal machine learning model corresponds to the first machine learning model. In another example embodiment, the ML models 216 may be implemented as the augmented intelligence models. In this scenario, the training data upon processing is provided as input to the augmented intelligence models for training the augmented intelligence models. Further, training of the ML models 216 and operations performed by the ML models 216 such as, extracting data attributes and computing confidence score and threshold factor are herein explained in detail with reference to FIG. 2, and therefore, they are not reiterated for the sake of brevity.

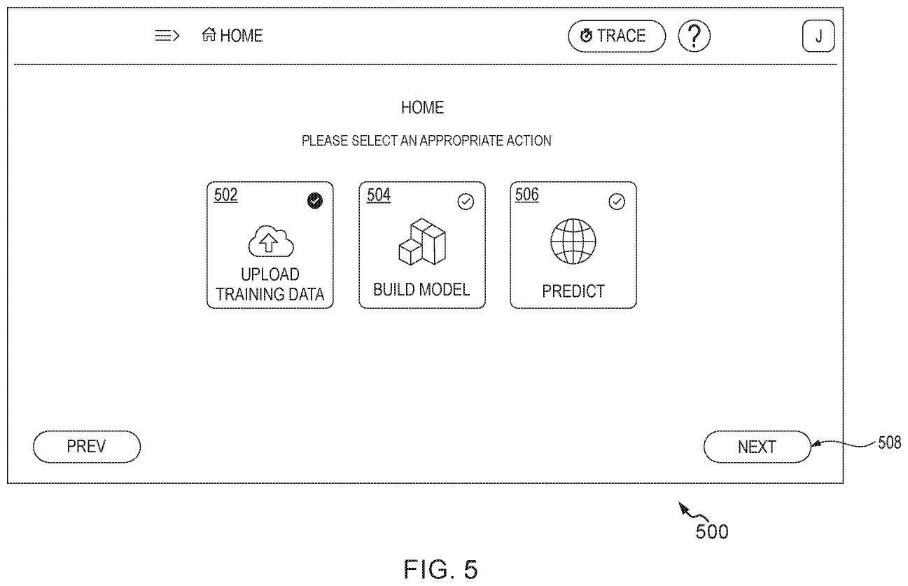

FIG. 5 represents an example representation of a user interface (UI) 500 depicting a home page of the application 112, in accordance with an embodiment of the present disclosure.

As shown in FIG. 5, the UI 500 is depicted to include a plurality of options such as an option 502, an option 504, and an option 506. The options 502, 504, and 506 are associated with the text “UPLOAD TRAINING DATA”, “BUILD MODEL”, and “PREDICT”, respectively. In one embodiment, each of the options 502, 504, and 506 is a clickable button that gets selected based on input received from the user 102. The user (e.g., the user 102) may provide input (either click/press/tap input) one of the options 502, 504, or 506 to select the specific button for performing operations such as uploading training data, training the ML model and predict outcomes, respectively. After selection of the desired option out of the options 502-506, the user 102 may click/press/tap on ‘NEXT’ button (see, 508) to proceed further with the selected option.

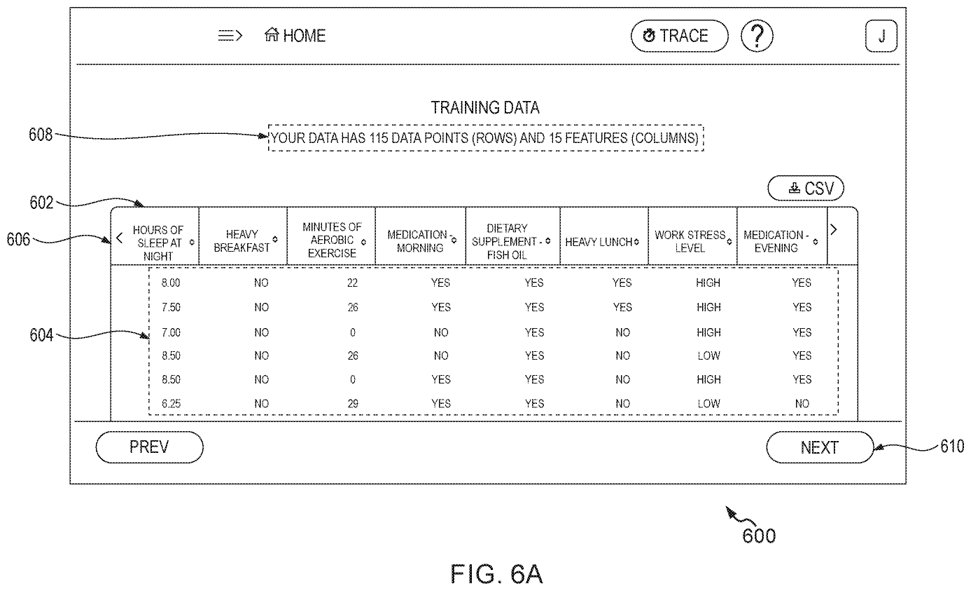

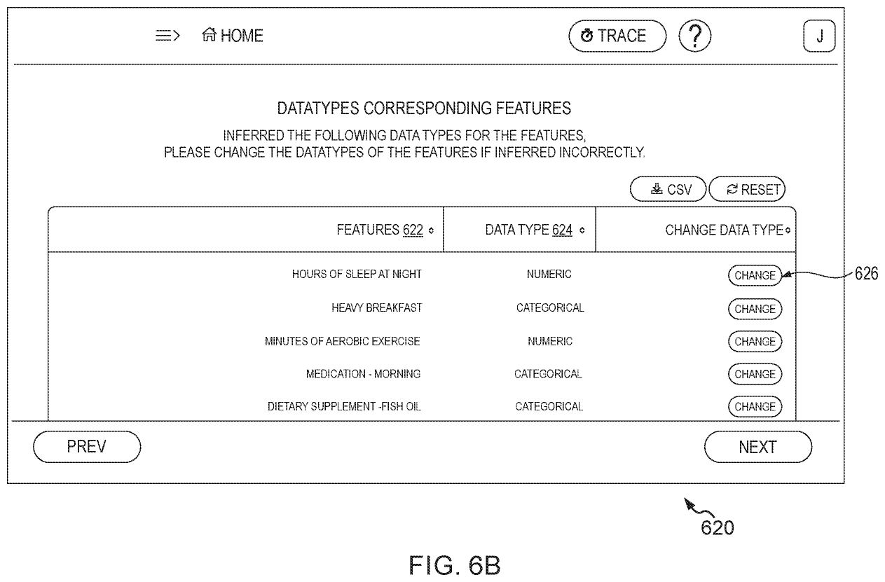

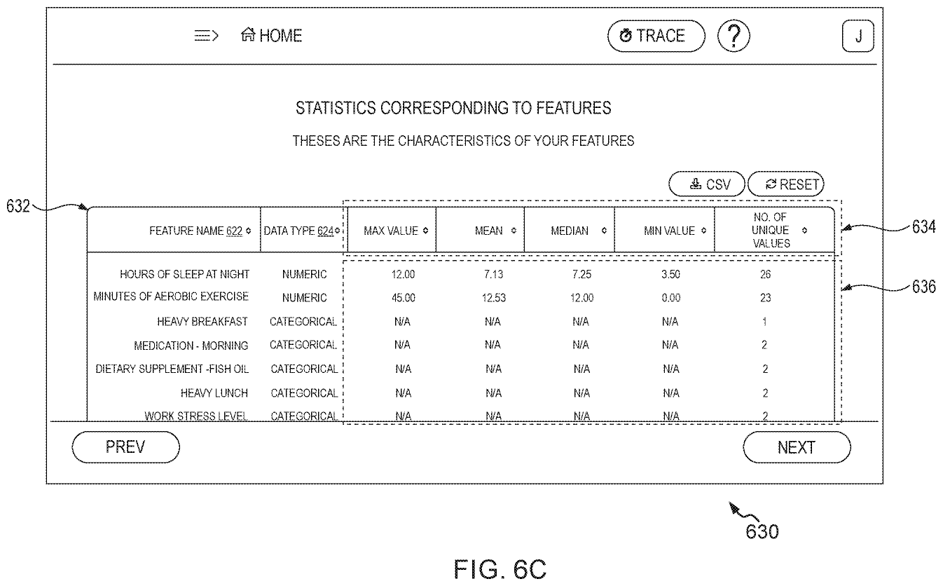

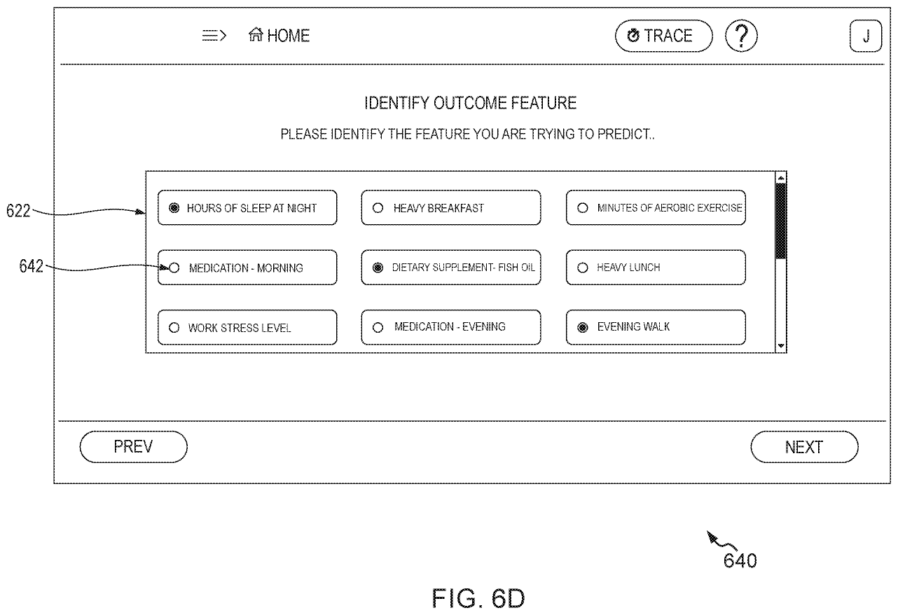

FIGS. 6A-6D, collectively, represent example representation of user interfaces (UI) for pre-processing of the training data, in accordance with an embodiment of the present disclosure.

Referring to FIG. 6A, an example representation of a UI 600 depicting breakdown of various features of training data 602 is illustrated, in accordance with an embodiment of the present disclosure. Prior to displaying the UI 600, the user 102 may be rendered with a UI (not shown in figures) of a webpage for uploading the training data 602 in the application 112 based on selection of the option 502. Thereafter, the application 112 renders the training data 602 in the UI 600. In one example, the training data 602 is identical to the training data 302 of FIG. 3. For example, the training data 602 includes information of a patients' (e.g., the user 102) blood pressure readings. Further, the application 112 is configured to analyze data points (see, 604) and features (see, 606) associated with the training data 602. The UI 600 is depicted to include a data field 608 for depicting number of the data points 604 and the features 606 (exemplary depicted to be “Your data has 115 data points (rows) and 15 features (columns)”) (see, 608). Thereafter, the application 112 may display user interface (UI) (not shown in figures) to select a set of features from the features 606 that are influential for deriving the plurality of outcomes. Moreover, a button labeled ‘NEXT’ (see, 610) is displayed at bottom of the training data 602. The user 102 may click/press/tap on the button 610 to proceed to the next UI in the application 112.

Referring to FIG. 6B, a UI 620 is depicted to include a set of features 622 and data type 624 associated each feature of the set of features 622. In one example, the set of features 622 is a subset of the features 606. The UI 620 is depicted on the user device 104 of the user after filtering the features 606 by selecting the set of features 622 and discarding the unselected features by the server system 200 based on the user inputs. In an example, the user 102 may select/un-select the set of features by clicking on a checkbox (not shown in FIG. 6B) corresponding to each of the features 606. In another example, the user 102 may select/un-select the set of features by clicking on the corresponding feature (selected feature may become bold, italic, or underline upon clicking) of the features 606. In one embodiment, the set of features 606 may correspond to a set of data attributes that are going to be extracted from the input data file at a future instance. The UI 600 depicts the set of features 622 exemplarily depicted to be “hours of sleep at night”, “heavy breakfast”, “minutes of aerobic exercise”, and so forth. Further, the application 112 is configured to automatically detect the data type 624 associated with each of the set of features 622. For example, for the feature “hours of sleep at night”, the data type is detected to be “numeric” as hours may be represented as a numeric value, and for the feature “heavy breakfast”, the data type is depicted to be “categorical”. Further, if the data type 624 associated with a particular feature is incorrect, the user 102 has an option to click/press/tap on a button (see, 626) to input the correct data type 624 for the corresponding feature of the set of features 622.

Referring to FIG. 6C, a UI 630 is depicted to include a statistic table 632, in accordance with an embodiment of the present disclosure. More specifically, the application 112 is configured to display the statistic table 632 based at least on the set of features 622 and the data type 624 associated with each of the feature 622. In one embodiment, the server system 200 is configured to generate the statistic table 632. As shown in the UI 630, the statistic table 632 includes parameters (exemplarily depicted to be maximum value, mean, median, minimum value, and so forth) (see, 634) and their standard values (see, 636) associated with each feature of the set of features 622 of the training data 602. Thereafter, the user 102 is rendered with a UI 640 to allow the user 102 to select at least one feature from the set of features 622 for further extracting the set of data attributes from the input data file and determining the outcome based on the set of data attributes (as shown in FIG. 6D). The user 102 may tap/click/press on a radio button (see, 642) associated with each feature (as shown in FIG. 6D). Additionally, the server system 200 may be configured to perform operations such as, outliers removal from the training data 602, shuffling of the processed training data 602, receiving inputs related to coordinates for visualizing the features 622 as a graphical representation, and the like. Thereafter, the processed training data may be uploaded to the database (such as the database 204) for further predictions in the future.

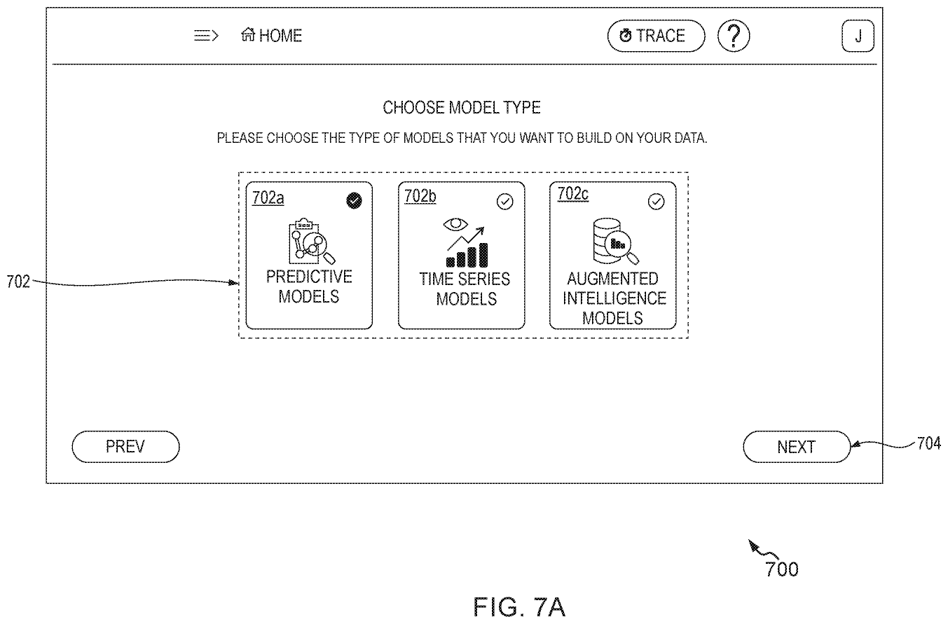

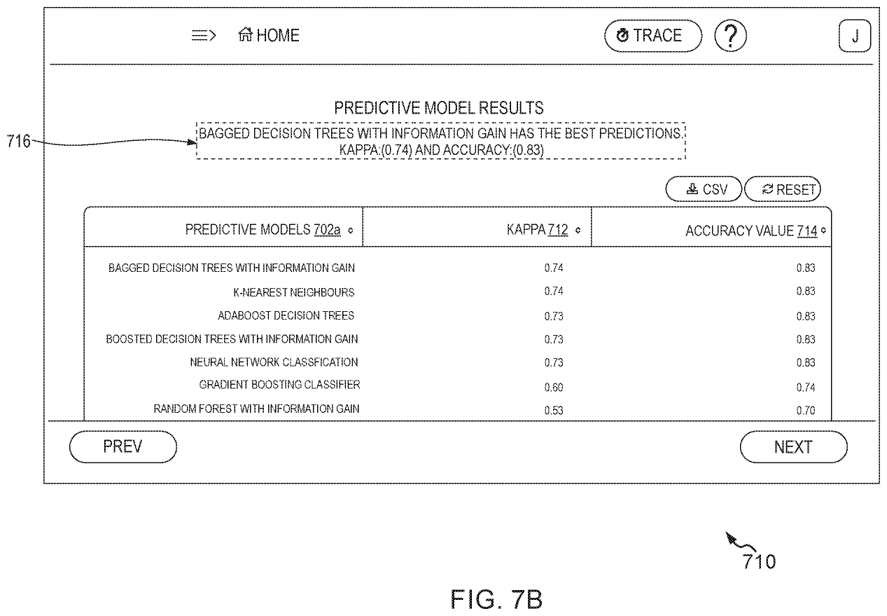

FIGS. 7A and 7B, collectively, represent example representation of user interfaces (UIs) for building and/or training the ML models (such as the ML models 216) based on the training data 602, in accordance with an embodiment of the present disclosure.

Referring to FIG. 7A, an example representation of a user interface (UI) 700 depicting a list of ML models 702 is illustrated, in accordance with an embodiment of the present disclosure. The UI 700 may be rendered by the application 112 on the user device 104 based on selection of the option 504. The list of ML models 702 is exemplarily depicted to include predictive models (see, 702a), time-series models (see, 702b), and augmented intelligence models (see, 702c). The aforementioned models 702a-702c may be represented as a selectable button on the UI 700 (as shown in FIG. 7A). The user 102 may click/press/tap on any of the models 702a-702c based on the requirement of the user 102. In an example, the user 102 may select the predictive models 702a for training. In one example, the selected predictive models 702a is depicted with a tick mark to highlight that the predictive models 702a has been selected by the user 102 (as shown in FIG. 7A).

After selecting the desired model type, the user 102 may click/press/tap on a button (see, 704) to initialize training of the selected model (here, the predictive models 702a). After selection of the ML model (i.e., the predictive models 702a), the server system 200 is configured to extract the features (such as the features 622) and build a statistic table similar to the statistic table 632. In one embodiment, additionally, the application 112 may be configured to receive inputs related to the removal of dependent outcomes, numerically derived outcomes, and the like, and thereafter, extract the features for generating the statistic table. In one embodiment, the statistic table (similar to the statistic table 632) is provided as an input to the predictive models 702a for training.

Referring to FIG. 7B, an example representation of a UI 710 depicting results (or the outcome prediction rate) associated with each of the predictive models 702a is illustrated, in accordance with an embodiment of the present disclosure. The predictive models 702a are exemplarily depicted to include “Bagged decision trees with information gain”, “K-Nearest Neighbors”, “AdaBoost decision trees”, “Neural network classification”, and so forth (as shown in FIG. 7B). As explained with reference to FIG. 2, each of the predictive models 702a is assigned with a K-value (or kappa) (see, 712) and an accuracy value (see, 714). The UI 710 is depicted to include a text field (see, 716) for depicting the optimal machine learning model from the predictive models 702a based at least on the K-value (see, 712) and the accuracy value (see, 714) of the predictive models 702a. The data field is exemplarily depicted to be “Bagged decision trees with information gain has best outcome prediction rate with the K-value=0.74, and accuracy=0.83” (see, 716). The optimal ML model (or the first ML model) is used for mining and/or determining the plurality of outcomes at future instances.

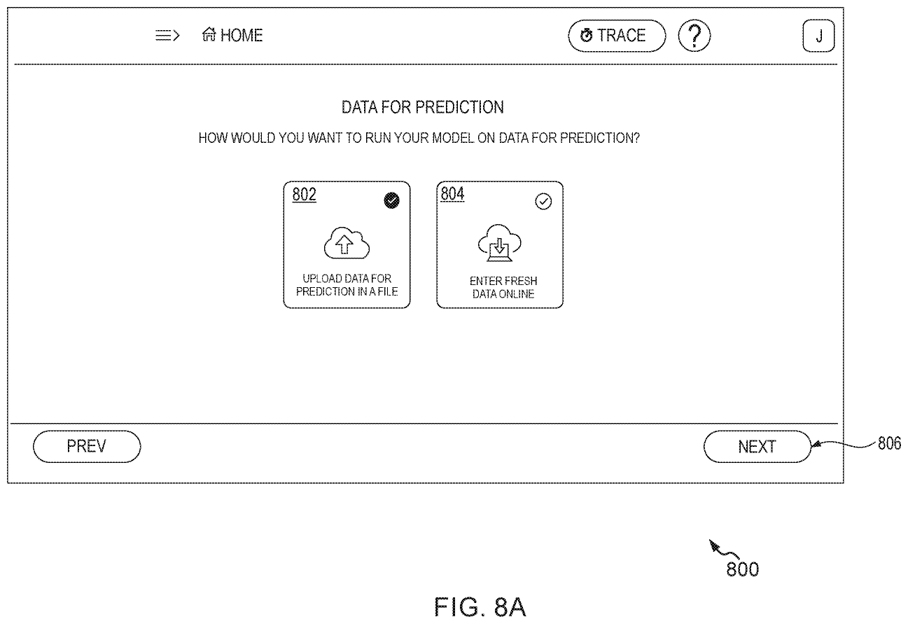

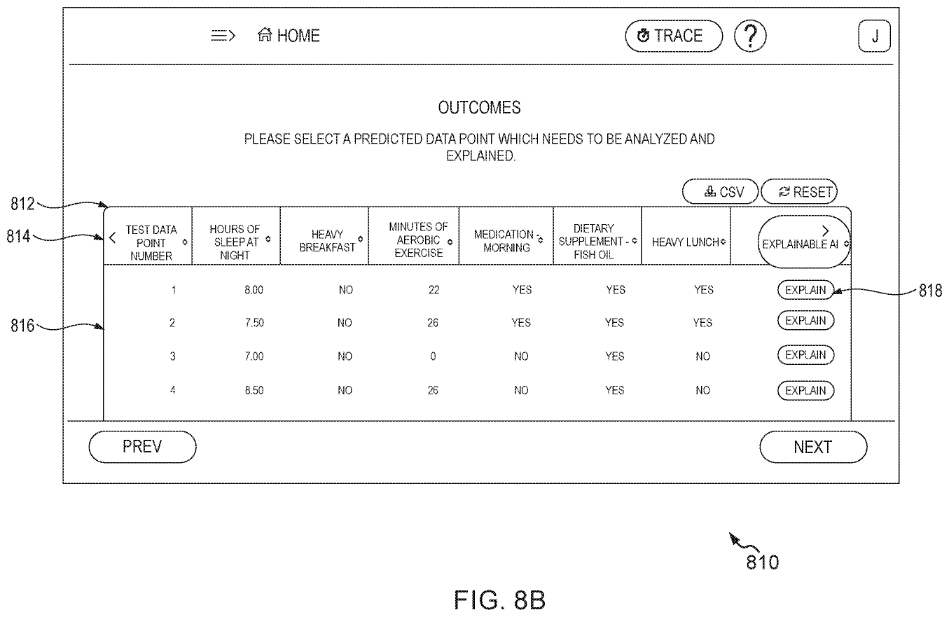

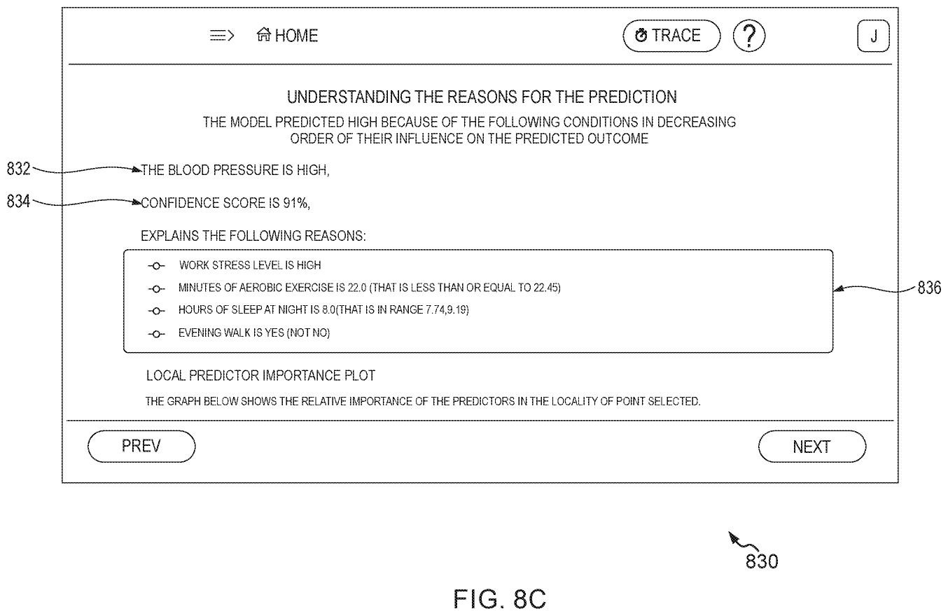

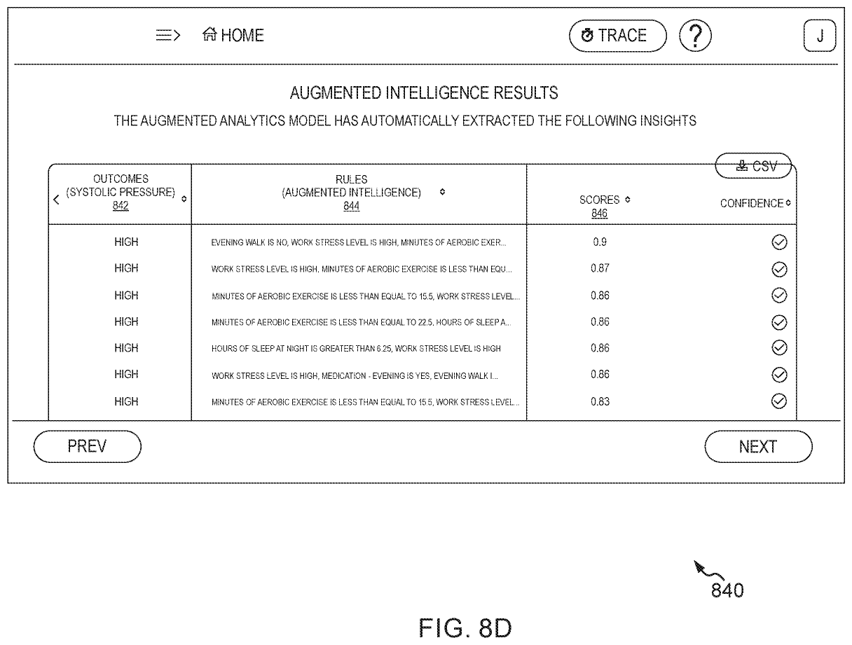

FIGS. 8A-8C, collectively, represent example representation of user interfaces (UIs) for determining the plurality of outcomes associated with the input data file, in accordance with an embodiment of the present disclosure.

Referring to FIG. 8A, an example representation of a UI 800 for receiving the input data file is illustrated, in accordance with an embodiment of the present disclosure. The UI 800 may be rendered in the application 112 if the user 102 clicked/pressed/tapped on the option 506 in FIG. 5. The UI 800 is depicted to include an option (see, 802) and an option (see, 804). In one embodiment, each of the options 802 and 804 may be a selectable button that can be selected by the user 102 by clicking/pressing/tapping on the corresponding button (i.e., 802 or 804). The user 102 may select the button 802 if the user 102 wants to upload the input data file. Upon clicking the button 802, the application 112 installed in the user device 104 may redirect the user 102 to a UI (not shown in figures) for uploading the input data file by accessing one or more data sources. Further, the user 102 may select the option 804 if the user 102 wants to manually enter the data in the application 112. Upon selection of the option 804, the user 102 may click/press/tap on a button (see, 806) to direct towards a UI 810 (as shown in FIG. 8B).

Referring to FIG. 8B, the UI 810 to include an outcome prediction table 812 is illustrated, in accordance with an embodiment of the present disclosure. The outcome prediction table (see, 812) is similar to the statistic table 632 generated during pre-processing of the training data 602. In one embodiment, after receiving the input data file, the server system 200 is configured to pre-process the input data file to extract a set of data attributes (see, 814) and a plurality of data points (see, 816) based on analysis of the input data file. The set of data attributes (see, 814) and the data points (see, 816) are extracted based on the trained ML models 216 (or the optimal ML model or the first ML model). In an embodiment, the application 112 may be configured to render a graphical representation of the outcome prediction table (see, 812). In another embodiment, the server system 200 is configured to render the graphical representation of the outcome prediction table (see, 812).

Further, the UI 810 is depicted to include a button (see, 818) along with text “EXPLAIN”. The user 102 may click/press/tap on the button 818 for augmenting his/her learning on the derived outcomes for the input data file based on the data points 816 associated with each of the data attributes 814.

After clicking the button 818, the user 102 is directed to a UI 830 (shown in FIG. 8C). As shown in FIG. 8C, the UI 830 is depicted to include an outcome (see, 832) (exemplarily depicted to be “The blood pressure is high”). As explained above, the outcome (see, 832) is derived based on the data points (see, 816) associated with data attributes (see, 814). The UI 830 is further depicted to display a confidence score (see, 834) associated with the outcome (see, 832). Further, reasons or data attributes that influence the outcome 832 are exemplarily depicted to be a) Work stress level is high, b) Minutes of aerobic exercise is 22.0 (that is less than or equal to 22.45) c) Hours of sleep at night is 8.0 (that is in range of 7.74, 9.19) and d) Evening walk is Yes (not No)”. It should be understood that each of the data attributes that are influencing the outcome 832 are associated with rules (see, 836). For example, the rule (such as the rules 836) for the data attribute: minutes of aerobic exercise is “less than or equal to 22.45”. It should be noted that the rule is generated by encoding the data attributes associated with the outcome 832 as a condition. The condition indicates a threshold associated with each data attribute (for example, 22.45 is the threshold for the data attribute “aerobic exercise” along with a comparative operator for enabling comparison of the data attributes associated with the outcome 832 and the threshold of each data attribute).

In one scenario, the server system 200 may be configured to render the outcomes based at least on the augmented intelligence models (such as the augmented intelligence models 702c). As shown in FIG. 8D, a UI 840 is depicted to include a plurality of outcomes (exemplarily depicted to be systolic pressure 842) generated by the augmented intelligence models. As explained above, each of the outcomes 842 is automatically mined from the input dataset pertaining to the systolic pressure of the patient over a period of time. Further, each of the outcomes 842 is associated with a confidence score (see, column 846). Additionally, the UI 840 is depicted to include reasons and/or rules (see, column 844) associated with each of the outcomes 842. It is to be noted that the outcomes and the associated rules are prioritized and/or ranked from top to bottom based at least on the confidence score associated with each of the outcomes 842.

Thus, the user interfaces as explained above generally refer to question and answer (Q&A) based user interfaces for allowing the users (e.g., the user 102) to perform operations for data upload, and processing and building AI/ML models for augmented intelligence functions to generate the outcomes that are in human understandable format, and the confidence score. In addition, the augmented intelligence models 702c and the time-series models 702b are trained for generating outcomes similar to the predictive models 702a. Therefore, operations involved in training and generating the outcomes associated with the augmented intelligence models 702c and the time-series models 702b are herein not explained in detail for the sake of brevity.

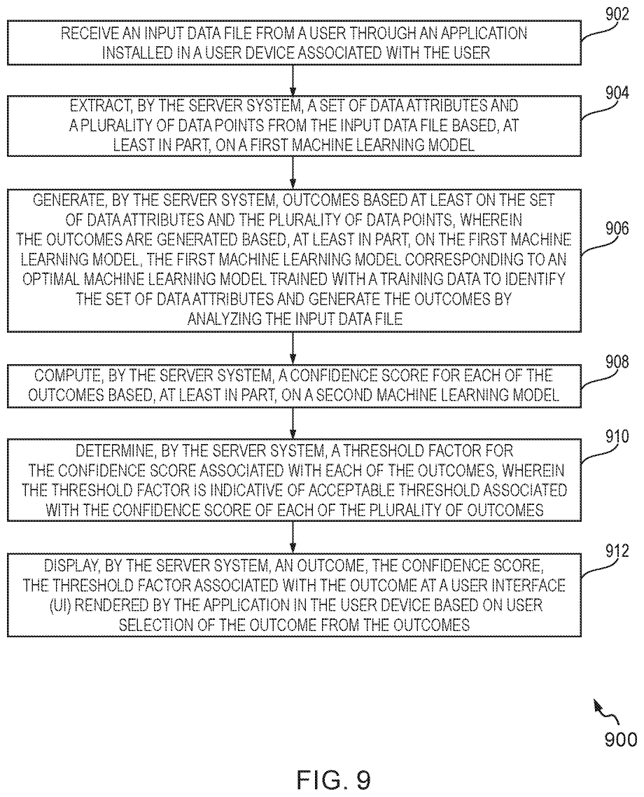

FIG. 9 illustrates a flow diagram of a computer-implemented method 900 for generating the plurality of outcomes from a given input data file and quantifying the confidence in each of the plurality of outcomes with the confidence score, in accordance with an embodiment of the present disclosure. The method 900 depicted in the flow diagram may be executed by, for example, the processor 206 of the server system 200. Operations of the flow diagram of the method 900, and combinations of operation in the flow diagram of the method 900, may be implemented by, for example, hardware, firmware, a processor, circuitry, and/or a different device associated with the execution of software that includes one or more computer program instructions. It is noted that the operations of the method 900 can be described and/or practiced by using a system other than these server systems. The method 900 starts at operation 902.

At operation 902, the method 900 includes receiving, by the server system 200, the input data file from the user 102 through the application 112 installed in the user device 104 associated with the user 102.

At operation 904, the method 900 includes extracting, by the server system 200, the set of data attributes and the plurality of data points from the input data file based, at least in part, on the first machine learning model.

At operation 906, the method 900 includes generating, by the server system 200, a plurality of outcomes based at least on the set of data attributes and the plurality of data points. The plurality of outcomes are generated based, at least in part, on the first machine learning model. The first machine learning model corresponds to an optimal machine learning model trained with the training data to identify the set of data attributes and generate the plurality of outcomes by analyzing the input data file.

At operation 908, the method 900 includes computing, by the server system 200, a confidence score for each of the plurality of outcomes based, at least in part, on a second machine learning model.

At operation 910, the method 900 includes determining, by the server system 200, a threshold factor for the confidence score associated with each of the plurality of outcomes. The threshold factor is indicative of an acceptable threshold associated with the confidence score of each of the plurality of outcomes.

At operation 912, the method 900 includes displaying, by the server system 200, the outcome, the confidence score, the threshold factor associated with the outcome at a user interface (UI) rendered by the application 112 in the user device 104 based on user selection of the outcome from the plurality of outcomes.

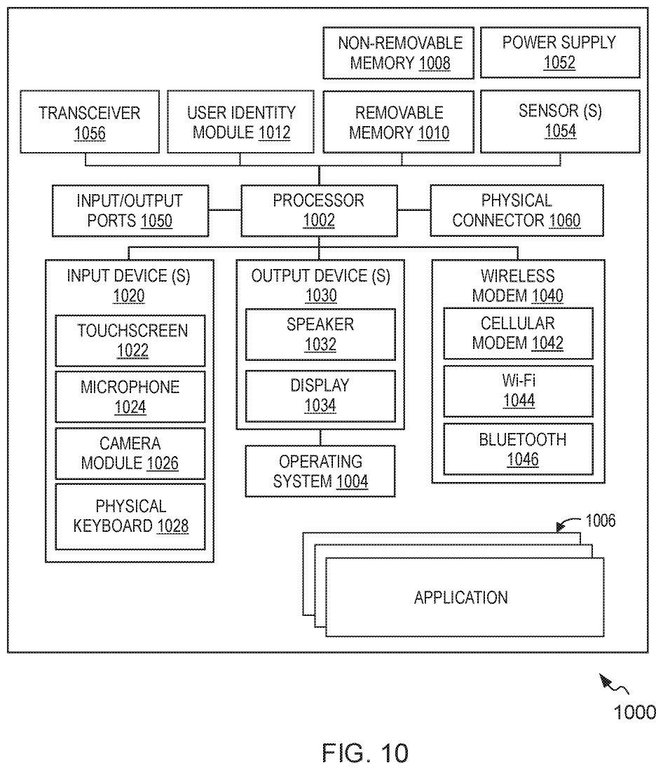

FIG. 10 is a simplified block diagram of an electronic device 1000 capable of implementing various embodiments of the present disclosure. For example, the electronic device 1000 may correspond to the user device 104 of FIG. 1. The electronic device 1000 is depicted to include one or more applications 1006. For example, the one or more applications 906 may include the application 112 of FIG. 1. The application 112 can be an instance of an application provided by the server system 106 or the server system 200. One of the one or more applications 1006 installed on the electronic device 1000 is capable of communicating with a server system for facilitating the users to perform operations such as data upload and processing and building AI/ML models for augmented intelligence functions to generate the plurality of outcomes that are in human understandable format and to quantify the plurality of outcomes with confidence scores.

It should be understood that the electronic device 1000 as illustrated and hereinafter described is merely illustrative of one type of device and should not be taken to limit the scope of the embodiments. As such, it should be appreciated that at least some of the components described below in connection with the electronic device 1000 may be optional and thus in an embodiment may include more, less, or different components than those described in connection with the embodiment of the FIG. 10. As such, among other examples, the electronic device 1000 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 1000 includes a controller or a processor 1002 (e.g., a signal processor, microprocessor, ASIC, or other control and processing logic circuitry) for performing such tasks as signal coding, data processing, image processing, input/output processing, power control, and/or other functions. An operating system 1004 controls the allocation and usage of the components of the electronic device 1000 and supports for one or more operations of the application (see, the applications 1006), such as the application 112 that implements one or more of the innovative features described herein. In addition, the applications 1006 may include common mobile computing applications (e.g., telephony applications, email applications, calendars, contact managers, web browsers, messaging applications) or any other computing application.

The illustrated electronic device 1000 includes one or more memory components, for example, a non-removable memory 1008 and/or removable memory 1010. The non-removable memory 1008 and/or the removable memory 1010 may be collectively known as a database in an embodiment. The non-removable memory 1008 can include RAM, ROM, flash memory, a hard disk, or other well-known memory storage technologies. The removable memory 1010 can include flash memory, smart cards, or a Subscriber Identity Module (SIM). The one or more memory components can be used for storing data and/or code for running the operating system 1004 and the applications 1006. The electronic device 1000 may further include a user identity module (UIM) 1012. The UIM 1012 may be a memory device having a processor built-in. The UIM 1012 may include, for example, a subscriber identity module (SIM), a universal integrated circuit card (UICC), a universal subscriber identity module (USIM), a removable user identity module (R-UIM), or any other smart card. The UIM 1012 typically stores information elements related to a mobile subscriber. The UIM 1012 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1000 can support one or more input devices 1020 and one or more output devices 1030. Examples of the input devices 1020 may include, but are not limited to, a touch screen/a display screen 1022 (e.g., capable of capturing finger tap inputs, finger gesture inputs, multi-finger tap inputs, multi-finger gesture inputs, or keystroke inputs from a virtual keyboard or keypad), a microphone 1024 (e.g., capable of capturing voice input), a camera module 1026 (e.g., capable of capturing still picture images and/or video images) and a physical keyboard 1028. Examples of the output devices 1030 may include, but are not limited to, a speaker 1032 and a display 1034. Other possible output devices can include piezoelectric or other haptic output devices. Some devices can serve more than one input/output function. For example, the touch screen 1022 and the display 1034 can be combined into a single input/output device.

A wireless modem 1040 can be coupled to one or more antennas (not shown in FIG. 10) and can support two-way communications between the processor 1002 and external devices, as is well understood in the art. The wireless modem 1040 is shown generically and can include, for example, a cellular modem 1042 for communicating at long range with the mobile communication network, a Wi-Fi compatible modem 1044 for communicating at short range with an external Bluetooth-equipped device, or a local wireless data network or router, and/or a Bluetooth-compatible modem 1046. The wireless modem 1040 is typically configured for communication with one or more cellular networks, such as a GSM network for data and voice communications within a single cellular network, between cellular networks, or between the electronic device 1000 and a public switched telephone network (PSTN).

The electronic device 1000 can further include one or more input/output ports 1050, a power supply 1052, one or more sensors 1054 for example, an accelerometer, a gyroscope, a compass, or an infrared proximity sensor for detecting the orientation or motion of the electronic device 1000 and biometric sensors for scanning biometric identity of an authorized user, a transceiver 1056 (for wirelessly transmitting analog or digital signals) and/or a physical connector 1000, which can be a USB port, IEEE 1294 (FireWire) port, and/or RS-232 port. The illustrated components are not required or all-inclusive, as any of the components shown can be deleted and other components can be added.

The disclosed method with reference to FIG. 9, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components)) and executed on a computer (e.g., any suitable computer, such as a laptop computer, netbook, Webbook, tablet computing device, smart phone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal-oxide-semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a server system, an input data file from a user through an application installed in a user device associated with the user;
extracting, by the server system, a set of data attributes and a plurality of data points from the input data file based, at least in part, on a first machine learning model;
generating, by the server system, a plurality of outcomes based at least on the set of data attributes and the plurality of data points, wherein the plurality of outcomes are generated based, at least in part, on the first machine learning model, the first machine learning model corresponding to an optimal machine learning model trained with training data for identifying the set of data attributes and generating the plurality of outcomes by analyzing the input data file;
computing, by the server system, a confidence score for each of the plurality of outcomes based, at least in part, on a second machine learning model;
determining, by the server system, a threshold factor for the confidence score associated with each of the plurality of outcomes, wherein the threshold factor is indicative of acceptable threshold associated with the confidence score of each of the plurality of outcomes; and
displaying, by the server system, an outcome, the confidence score, and the threshold factor associated with the outcome at a user interface (UI) rendered by the application in the user device based on user selection of the outcome from the plurality of outcomes.

2. The computer-implemented method as claimed in claim 1, wherein the second machine learning model is trained with the training data used for training the first machine learning model for computing the confidence score, the training data comprising a plurality of datasets, features associated with each dataset of the plurality of datasets, and outcomes derived from the features.

3. The computer-implemented method as claimed in claim 1, wherein computing the confidence score for each of the plurality of outcomes comprises:
filtering the input data file by applying each outcome generated by the first machine learning model; and
generating the confidence score for each of the plurality of outcomes based at least on analyzing efficacy of each of the outcomes with the filtered input data file.

4. The computer-implemented method as claimed in claim 1, wherein the second machine learning model is modeled based on parameters comprising at least one of root mean square error (RMSE) function, accuracy, proportion of the input data file upon filtering outliers from the input data file, and perception for computing the confidence score for each data attribute relative to the population of the training data.

5. The computer-implemented method as claimed in claim 1, wherein the first machine learning model and the second machine learning model correspond to augmented analytical models modeled as a combination of white-box models based at least on decision tree algorithm and linear regression algorithm.

6. The computer-implemented method as claimed in claim 1, wherein the first machine learning model and the second machine learning model is implemented as at least one of: predictive models, time-series models, and forecasting models.

7. The computer-implemented method as claimed in claim 1, further comprising:
receiving, by the server system, the training data as an input for training one or more machine learning models;
facilitating, by the server system, pre-processing of the training data, prior to training of the one or more machine learning models, wherein the pre-processing of the training data comprises:
receiving, by the server system, inputs related to a set of features associated with the training data, the set of features correspond to the set of data attributes,
determining, by the server system, a data type associated with each feature of the set of features,
generating, by the server system, a statistic table based at least on the set of features and the data type associated with each feature, the statistic table comprising parameters and standard values of parameters associated with each feature of the set of features of the training data, and
receiving, by the server system, inputs related to selection of at least one feature from the set of features for extracting the set of data attributes from the input data file and determining the outcome based on the set of data attributes, and coordinates associated with the set of features; and
upon pre-processing the training data, inputting, by the server system, the training data to the one or more machine learning models based at least on selection of a type of machine learning model to be trained.

8. The computer-implemented method as claimed in claim 1, wherein determining the optimal machine learning model comprises:
evaluating, by the server system, a K-value and an accuracy value for each of the one or more machine learning models based on analyzing an outcome prediction rate associated with each of the one or more machine learning models, the one or more machine learning models being one of a classification machine learning model; and
determining, by the server system, the optimal machine learning model from the one or more machine learning models based at least on the K-value and the accuracy value, the optimal machine learning model corresponding to the first machine learning model.

9. The computer-implemented method as claimed in claim 1, wherein determining the optimal machine learning model comprises:
evaluating, by the server system, an R-squared and an RMSE value for each of the one or more machine learning models based on analyzing an outcome prediction rate associated with each of the one or more machine learning models, the one or more machine learning models being one of a regression machine learning model; and
determining, by the server system, the optimal machine learning model from the one or more machine learning models based at least on the R-value and the RMSE value, the optimal machine learning model corresponding to the first machine learning model.

10. The computer-implemented method as claimed in claim 1, wherein the server system is configured to provide explanation of the outcome based at least on encoding the set of data attributes associated with each outcome as a condition, wherein the condition indicates a threshold associated with each data attribute of the set of data attributes along with a comparative operator for enabling comparison of the set of data attributes associated with each of the plurality of outcomes with the threshold of each data attribute.

11. A server system, comprising:
a communication interface;
a memory comprising executable instructions; and
a processor communicably coupled to the communication interface and the memory, the processor configured to cause the server system to perform at least:
receive an input data file from a user through an application installed in a user device associated with the user,
extract a set of data attributes and a plurality of data points from the input data file based, at least in part, on a first machine learning model,
generate a plurality of outcomes based at least on the set of data attributes and the plurality of data points, wherein the plurality of outcomes are generated based, at least in part, on the first machine learning model, the first machine learning model corresponding to an optimal machine learning model trained with training data to identify the set of data attributes and generate the plurality of outcomes by analyzing the input data file,
compute a confidence score for each of the plurality of outcomes based, at least in part, on a second machine learning model,
determine a threshold factor for the confidence score associated with each of the plurality of outcomes, wherein the threshold factor is indicative of acceptable threshold associated with the confidence score of each of the plurality of outcomes, and
display an outcome, the confidence score, and the threshold factor associated with the outcome at a user interface (UI) rendered by the application in the user device based on user selection of the outcome from the plurality of outcomes.

12. The server system as claimed in claim 11, wherein the second machine learning model is trained with the training data used for training the first machine learning model for computing the confidence score, the training data comprising a plurality of datasets, features associated with each dataset of the plurality of datasets, and outcomes derived from the features.

13. The server system as claimed in claim 11, wherein the server system is further caused to:
filter the input data file by applying each outcome generated by the first machine learning model; and
generate the confidence score for each of the plurality of outcomes based at least on analyzing efficacy of each of the plurality of outcomes with the filtered input data file.

14. The server system as claimed in claim 11, wherein the second machine learning model is modeled based on parameters comprising at least one of root mean square error (RMSE) function, accuracy, proportion of the input data file upon filtering outliers from the input data file, and perception for computing the confidence score for each data attribute relative to the population of the training data.

15. The server system as claimed in claim 11, wherein the first machine learning model and the second machine learning model correspond to augmented analytical models modeled as a combination of white-box models based at least on decision tree algorithm and linear regression algorithm.

16. The server system as claimed in claim 11, wherein the first machine learning model and the second machine learning model is implemented as at least one of: predictive models, time-series models, and forecasting models.

17. The server system as claimed in claim 11, wherein the server system is further caused to:
receive the training data as input for training one or more machine learning models;
facilitate pre-processing of the training data, prior to training of the one or more machine learning models, wherein the pre-processing of the training data comprises:
receive inputs related to a set of features associated with the training data, the set of features correspond to the set of data attributes,
determine a data type associated with each feature of the set of features,
generate a statistic table based at least on the set of features and the data type associated with each feature, the statistic table comprising parameters and standard values of parameters associated with each feature of the set of features of the training data, and
receive inputs related to selection of at least one feature from the set of features for extracting the set of data attributes from the input data file and determining the outcome based on the set of data attributes, and coordinates associated with the set of features; and
upon pre-processing the training data, input the training data to the one or more machine learning models based at least on selection of a type of machine learning model to be trained.

18. The server system as claimed in claim 11, wherein the server system is further caused to:
evaluate a K-value and an accuracy value for each of the one or more machine learning models based on analyzing an outcome prediction rate associated with each of the one or more machine learning models; and
determine the optimal machine learning model from the one or more machine learning models based at least on the K-value and the accuracy value, the optimal machine learning model corresponding to the first machine learning model.

19. The server system as claimed in claim 11, wherein the server system is further caused to:
evaluate an R-squared and an RMSE value for each of the one or more machine learning models based on analyzing an outcome prediction rate associated with each of the one or more machine learning models, the one or more machine learning models being one of a regression machine learning model; and
determine the optimal machine learning model from the one or more machine learning models based at least on the R-value and the RMSE value, the optimal machine learning model corresponding to the first machine learning model.

20. The server system as claimed in claim 11, wherein the server system is configured to provide explanation of the outcome based at least on encoding the set of data attributes associated with each outcome as a condition, wherein the condition indicates a threshold associated with each data attribute of the set of data attributes along with a comparative operator for enabling comparison of the set of data attributes associated with each of the plurality of outcomes with the threshold of each data attribute.
